(19) United States
(12) Patent Application Publication
(10) Pub. No.: US 2026/0079739 A1
(43) Pub. Date: Mar. 19, 2026

(54) LIVENESS MONITORING TO PROVIDE DETERMINISTIC ASCERTAINMENT OF A FUNCTIONAL STATUS OF NODES IN A NETWORKED ENVIRONMENT

(71) Applicant: NetApp, Inc., San Jose, CA (US)

(72) Inventors: Sangramsinh Pandurang Pawar, Bedford, MA (US); Yanbei Wang, Southborough, MA (US)

(73) Assignee: NetApp, Inc., San Jose, CA (US)

(21) Appl. No.: 19/036,971

(22) Filed: Jan. 24, 2025

Related U.S. Application Data
(60) Provisional application No. 63/694,263, filed on Sep. 13, 2024.

(51) Int. Cl. G06F 9/455; H04L 43/10

(52) U.S. Cl. CPC G06F 9/45558; H04L 43/10; G06F 2009/4557; G06F 2009/45591; G06F 2009/45595

(57) ABSTRACT

A liveness monitoring architecture to deterministically ascertain the functional status of nodes in a high-availability (HA) environment to more efficiently recover from a split-brain condition is disclosed.

### CROSS-REFERENCE TO RELATED APPLICATION

This application claims priority of U.S. Provisional Application No. 63/694,263, filed September 13, 2024, entitled “Liveness Monitoring to Deterministically Ascertain the Functional Status of Nodes in a High-Availability (HA) Environment,” the contents of which are incorporated herein by reference in their entirety.

### BACKGROUND

In high-availability (HA) environments various components (e.g., nodes, servers, storage arrays) have one or more corresponding backup components that can be utilized to maintain a desired level of availability if a primary component should fail or begin to fail.

To manage HA environments, typically, a node HA pair may share heartbeat signals with each other to communicate whether a corresponding component is currently functioning properly. The heartbeat signals provide an indication that the source of the heartbeat signal is functioning. However, various conditions can result in these heartbeat signals being insufficient for their intended purposes. For example, if a cable carrying a heartbeat signal is damaged the source node may be functioning properly, but one or more other nodes may react as if the node is not functioning properly. This can result in a split-brain condition.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a block diagram of an example shared HA pair that deterministically ascertains the functional status of nodes in the HA environment to more efficiently recover from a split-brain condition.

FIG. 2 is a block diagram of an example shared-nothing HA pair that deterministically ascertains the functional status of nodes in the HA environment to more efficiently recover from a split-brain condition.

FIG. 3 is conceptual illustration of a first example liveness packet having a timestamp that can be used as described herein.

FIG. 4 is a block diagram of an example virtual machine HA pair that deterministically ascertains the functional status of VMs in the HA environment.

FIG. 5 is a flow diagram corresponding to an example approach to deterministically ascertains the functional status of nodes in the HA environment to more efficiently recover from a split-brain condition.

FIG. 6 is a flow diagram corresponding to an example approach to deterministically ascertains the functional status of nodes in the HA environment to more efficiently recover from a split-brain condition.

FIG. 7 is a flow diagram corresponding to an example approach to deterministically ascertains the functional status of nodes in the HA environment to more efficiently recover from a split-brain condition.

FIG. 8 is a block diagram of an example system to deterministically ascertain the functional status of nodes in the HA environment to more efficiently recover from a split-brain condition.

FIG. 9 is a block diagram of a computing platform that can provide one or more virtual machines and deterministically ascertain the functional status of nodes in the HA environment to more efficiently recover from a split-brain condition.

FIG. 10 illustrates one embodiment of a block diagram of an aggregate.

### DETAILED DESCRIPTION

The following description outlines numerous details to provide a thorough understanding of the present disclosure. It will be apparent, however, to one skilled in the art that the present disclosure may be practiced without some of these specific details. In other instances, well-known structures and devices are shown in block diagram form to avoid obscuring the underlying principles of the present disclosure.

One proposed solution to the shortcomings presented above is to utilize one or more heartbeat signals and a mailbox that is accessed via an application program interface (API). However, brownout conditions at the API can result in the inability to write and/or read the mailbox, which can result in a split-brain condition. In general, a “split-brain condition” occurs when two or more parts of a distributed system lose communication with each other but continue to operate independently, often leading to inconsistent or conflicting data or operations. This typically happens in clustered systems or high-availability setups, where multiple nodes are designed to work together to provide redundancy and fault tolerance.

In a shared HA configuration, if the primary node experiences a network outage but still has the ability to write to the mailbox, the requesting entity may experience a loss of service while the control mechanisms of the HA environment consider the primary node to be functioning properly. Thus, a simple mailbox-based solution is insufficient to address the split-brain condition and potentially other undesirable situations.

To address these and other issues, a new and improved “liveness” mechanism is described that deterministically ascertains the functional status of nodes in the HA environment to more efficiently recover from a split-brain condition and/or other undesirable situations. In an example, a control plane of a cloud storage provider can use an API and/or node mediator to check for entity (e.g., node, virtual machine (VM), storage devices) liveness within the HA environment. In an example, VM liveness information is pushed to a widely available endpoint (e.g., a cloud database) so that the control plane (and/or one or more HA control agents) can efficiently check the liveness information. In an example, besides a timestamp of a last update from the VM, other information about the VM (e.g., Node State, Aggregate State, Network Interface Card (NIC) State, and Object Store State) will also be updated periodically to help control plane make decisions.

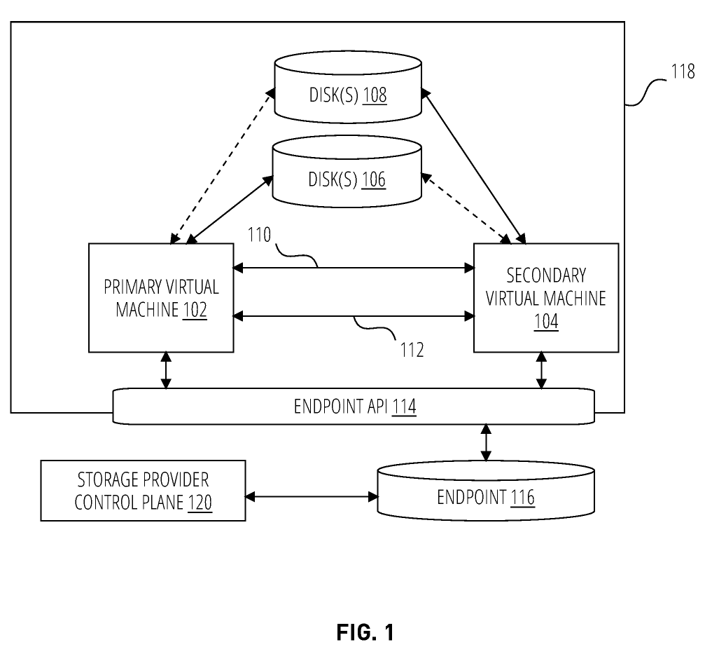

FIG. 1 is a block diagram of an example shared HA pair that deterministically ascertains the functional status of nodes in the HA environment to more efficiently recover from a split-brain condition. The configuration as illustrated in FIG. 1 is considered a shared HA configuration because both primary virtual machine 102 and secondary virtual machine 104 both have access to both of disk(s) 106 and disk(s) 108, which will be discussed in greater detail below.

In the example of FIG. 1, primary virtual machine 102 and secondary virtual machine 104 are configured as an HA pair. In other configurations, more than two virtual machines can be configured as an HA cluster (i.e., as a group of more than two VMs meeting HA parameters). In an example primary virtual machine 102 and secondary virtual machine 104 exchange heartbeat signals (e.g., heartbeat channel 110, heartbeat channel 112).

In an example, both primary virtual machine 102 and secondary virtual machine 104 utilized endpoint API 114 to write to and or read from endpoint 116. In an example, endpoint 118 is a cloud-hosted database (structured or unstructured) accessible by storage provider control plane 122; however, in other configurations a different endpoint solution can be used. In an example, both primary virtual machine 102 and secondary virtual machine 104 push liveness information (e.g., timestamp, node state, NIC state) to endpoint 118 via endpoint API 116. Endpoint API 116 provides an interface between endpoint 118 and HA environment 120 and is unique to endpoint 118. That is, for endpoints having different characteristics, different corresponding APIs are utilized. In an example, endpoint API 116 is a REpresentational State Transfer (REST) API.

In various environments, endpoint 116 may be implemented using structures and interfaces appropriate for the environment. For example, in an Amazon Web Services (AWS)-based environment, endpoint 118 can be provided by a DynamoDB instance. AWS (without derogation of any third-party trademark rights) is provided by Amazon Web Services, Inc., a subsidiary of Amazon.com, Inc. DynamoDB is a proprietary NoSQL database provided via AWS that offers a fast persistent key-value datastore with built-in support for replication, autoscaling, encryption at rest, and on-demand backup. Other environments (e.g.., AZURE from MICROSOFT, Google Cloud Platform from GOOGLE, Alibaba Cloud from ALIBABA, Oracle Cloud from ORACLE, IBM Cloud from IBM, VMWare Cloud from VMWare, Salesforce Cloud from SALESFORCE.COM, INC., or any other suitable environment). All trademarks, service marks, product names, and company names or logos cited herein are the property of their respective owners. The use of these trademarks, service marks, product names, or company names or logos is for identification and reference purposes only and does not imply any association with, endorsement by, or approval of the respective trademark owners.

During normal operation, primary virtual machine 102 provides data and/or services to requests received by HA environment 118. In an example, primary virtual machine 102 provides a heartbeat signal to secondary virtual machine 104 via heartbeat channel 110. The heartbeat signal has an associated frequency so that secondary virtual machine 104 can determine when the heartbeat signal is delayed or absent. Similarly, secondary virtual machine 104 provides a heartbeat signal to primary virtual machine 102 via heartbeat channel 112. The heartbeat signal has an associated frequency so that primary virtual machine 102 can determine when the heartbeat signal is delayed or absent. In an example, one or more of the heartbeat signals is optional and the HA operation can be based on the liveness signals to endpoint 116 alone.

During normal operation, primary virtual machine 102 sends a liveness packet to endpoint 116 via endpoint API 114. The liveness packet can contain various types of information that can be utilized by secondary virtual machine 104 to determine which virtual machine should be servicing requests for data and/or services to HA environment 118. In an example, secondary virtual machine 104 can also send a liveness packet to endpoint 116 via endpoint API 114. The liveness packet from secondary virtual machine 104 can contain the same or different information as compared to the liveness packet from primary virtual machine 102. Thus, primary virtual machine 102 and/or secondary virtual machine 104 can push liveness information to endpoint 116. In an example, the frequency at which information is pushed to endpoint 116 can be the same or different as compared to the frequency of the heartbeat signals (e.g., heartbeat channel 110, heartbeat channel 112).

In an example, a control agent periodically reads the most recent entry to endpoint 116 and evaluates one or more fields from the entry to determine the operational status of primary virtual machine 102 and/or secondary virtual machine 104. In another example, storage provider control plane 120 periodically reads the most recent entry to endpoint 116 and evaluates one or more fields from the entry to determine the operational status of primary virtual machine 102 and/or secondary virtual machine 104.

In the case of a brownout at endpoint API 114 due to a heavy workload, for example, a system thread in primary virtual machine 102 can be used to push liveness information out during a heavy workload. In some environments, endpoint API 114 may be starved in a heavy workload situation because data plane threads can have a higher priority than liveness packets.

When the nodes of HA environment 118, which is a shared-HA configuration, lose network connectivity, but disk access remains, a prolonged data outage can occur because both of the nodes go out of quorum. This situation can be mitigated by shutting down the affected VM but, without the liveness mechanism described herein, components of the control plane of HA environment 118 have no way to discover which is the affected VM. For a non-shared HA configuration, a mediator agent can be used to determine if a VM is impacted because the mailbox functionality (e.g., on the mediator agent) is not updated in the case of a network failure leading to a partner VM (e.g., secondary virtual machine 104) talking over for the affected node (e.g., primary virtual machine 102). By updating liveness information frequently, the control plane can determine if a VM is still functioning. If the VM loses network connectivity, it cannot update endpoint 116 and the control plane can determine if the VM is dead after some time threshold and the control plane can intervene to prevent a prolonged data outage.

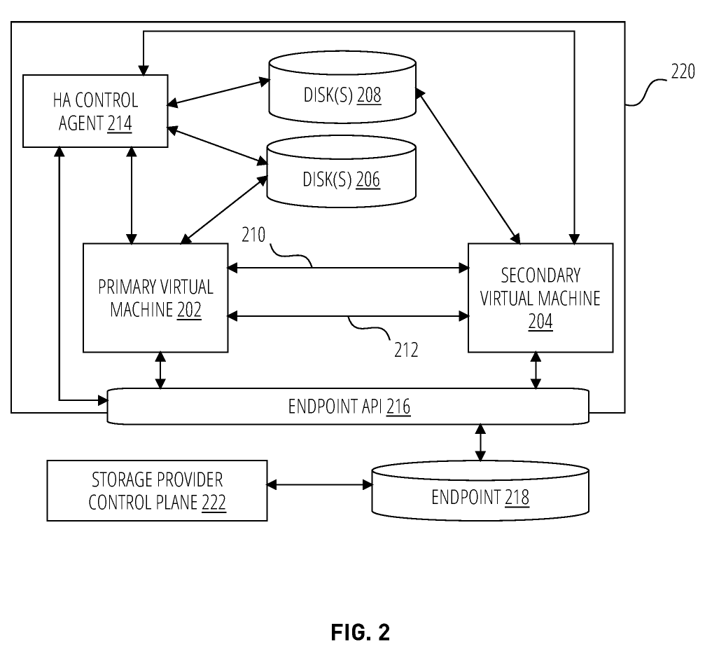

FIG. 2 is a block diagram of an example shared-nothing (or non-shared) HA pair that deterministically ascertains the functional status of nodes in the HA environment to more efficiently recover from a split-brain condition. The configuration as illustrated in FIG. 2 is considered a shared-nothing HA configuration because primary virtual machine 202 has access to disk(s) 206 and not to disk(s) 208, and secondary virtual machine 204 has access to disk(s) 208 and not to disk(s) 206. Thus, primary virtual machine 202 and secondary virtual machine 204 do not share disks.

In an example, both primary virtual machine 202 and secondary virtual machine 204 utilized endpoint API 216 to write to and or read from endpoint 218. In an example, endpoint 218 is a cloud-hosted database; however, in other configurations a different endpoint solution can be used. In an example, both primary virtual machine 202 and secondary virtual machine 204 push liveness information (e.g., timestamp, node state, NIC state) to endpoint 218 via endpoint API 216. Endpoint API 216 provides an interface between 218 and HA environment 220 and is unique to endpoint 218. That is, for endpoints having different characteristics, different corresponding APIs are utilized. In an example, endpoint API 216 is a REST API.

In various environments, endpoint 218 may be implemented using structures and interfaces appropriate for the environment. For example, in an Amazon Web Services (AWS)-based environment, endpoint 218 can be provided by a DynamoDB instance. AWS is provided by Amazon Web Services, Inc., a subsidiary of Amazon.com, Inc. DynamoDB is a proprietary NoSQL database provided via AWS that offers a fast persistent key-value datastore with built-in support for replication, autoscaling, encryption at rest, and on-demand backup. Other environments (e.g.., AZURE from MICROSOFT, Google Cloud Platform from GOOGLE, Alibaba Cloud from ALIBABA, Oracle Cloud from ORACLE, IBM Cloud from IBM, VMWare Cloud from VMWare, Salesforce Cloud from SALESFORCE.COM, INC., or any other suitable environment). All trademarks, service marks, product names, and company names or logos cited herein are the property of their respective owners. The use of these trademarks, service marks, product names, or company names or logos is for identification and reference purposes only and does not imply any association with, endorsement by, or approval of the respective trademark owners

In an example, HA control agent 214 is coupled with, and has access to, primary virtual machine 202, secondary virtual machine 204, disk(s) 206, disk(s) 208 and endpoint 218 via endpoint API 216 As described in greater detail below, HA control agent 214 provides control functionality for HA environment 220 including participating in operations that deterministically ascertains the functional status of primary virtual machine 202 and secondary virtual machine 204 in HA environment 220 to more efficiently recover from a split-brain condition.

During normal operation, primary virtual machine 202 provides data and/or services to requests received by HA environment 220. In an example, primary virtual machine 202 provides a heartbeat signal to secondary virtual machine 204 via heartbeat channel 210. The heartbeat signal has an associated frequency so that secondary virtual machine 204 can determine when the heartbeat signal is delayed or absent. Similarly, secondary virtual machine 204 provides a heartbeat signal to primary virtual machine 202 via heartbeat channel 212. The heartbeat signal has an associated frequency so that primary virtual machine 202 can determine when the heartbeat signal is delayed or absent. In an example, one or more of the heartbeat signals is optional and the HA operation can be based on the liveness signals to endpoint 218 alone. However, one or more heartbeat signals can provide HA control agent 214 with additional information that can be utilized to manage the operation of HA environment 220.

HA control agent 214 is interconnected to the various components of HA environment 220 to provide control and/or management functionality. One responsibility of HA control agent 214 is to determine whether primary virtual machine 202 is operating within expected parameters. To accomplish this management functionality, HA control agent 214 is coupled with various components (e.g., primary virtual machine 202, secondary virtual machine 204, disk(s) 206, disk(s) 208) of HA environment 220. In an example, HA control agent 214 acts as a moderator for HA environment 220.

During normal operation, primary virtual machine 202 sends a liveness packet to endpoint 218 via endpoint API 216. The liveness packet can contain various types of information that can be utilized by secondary virtual machine 204 and/or HA control agent 214 to determine which virtual machine should be servicing requests for data and/or services to HA environment 220. In an example, secondary virtual machine 204 can also send a liveness packet to endpoint 218 via endpoint API 216. The liveness packet from secondary virtual machine 204 can contain the same or different information as compared to the liveness packet from primary virtual machine 202. Thus, primary virtual machine 202 and/or secondary virtual machine 204 can push liveness information to endpoint 218. In an example, the frequency at which information is pushed to endpoint 218 can be the same or different as compared to the frequency of the heartbeat signals.

In an example, HA control agent 214 periodically reads the most recent entry to endpoint 218 and evaluates one or more fields from the entry to determine the operational status of primary virtual machine 202 and/or secondary virtual machine 204. In an example, storage provider control plane 222 periodically reads the most recent entry to endpoint 218 and evaluates one or more fields from the entry to determine the operational status of primary virtual machine 202 and/or secondary virtual machine 204.

In the case of a brownout at endpoint API 216 due to a heavy workload or HA control agent 214 crashes, a system thread in primary virtual machine 202 can be used to push liveness information out during a heavy workload. In some environments, endpoint API 216 may be starved in a heavy workload situation because data plane threads can have a higher priority than liveness packets. In the HA control agent 214 crash scenario, a network connection with endpoint 218 is established at boot time and requires HA control agent 214 to provide translation so that the connection can be used for liveness updates to endpoint 218. In an example, once the connection is established and HA control agent 214 crashes, the connection can continue to be utilized for updates to endpoint 218.

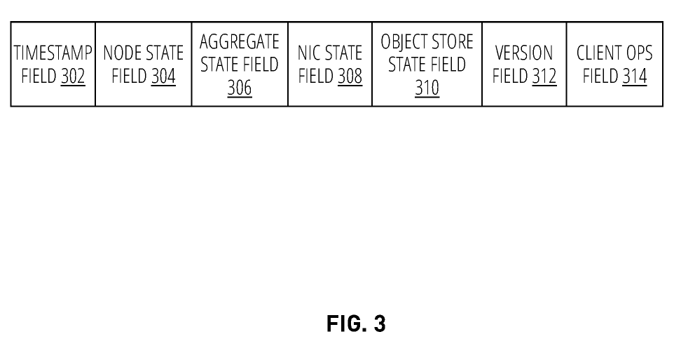

FIG. 3 is conceptual illustration of a first example liveness packet having a timestamp that can be used as described herein. In the example packet of FIG. 3, timestamp field 302 is utilized to provide timestamp information to the endpoint (e.g., endpoint 116, endpoint 218). Node state field 304 is utilized to provide state information corresponding to the source node (e.g., primary virtual machine 102, secondary virtual machine 104, primary virtual machine 202, secondary virtual machine 204). Aggregate state field 306 is utilized to provide state information corresponding to an aggregate (e.g., aggregate 1002) to which the node corresponding to node state field 304 belongs. NIC state field 308 is utilized to provide state information for one or more network interface cards (NICs) corresponding to the host node. This information can include, for example, a time since a last transmission from a NIC. NICs can be used to transmit heartbeat information, to read and write to a disk, to access the endpoint, etc. Object store state field 310 is utilized to provide state information for the storage fabric corresponding to the aggregate. Version field 312 is utilized to provide version information for the liveness entry. Client OPs field 314 is used to client operational information.

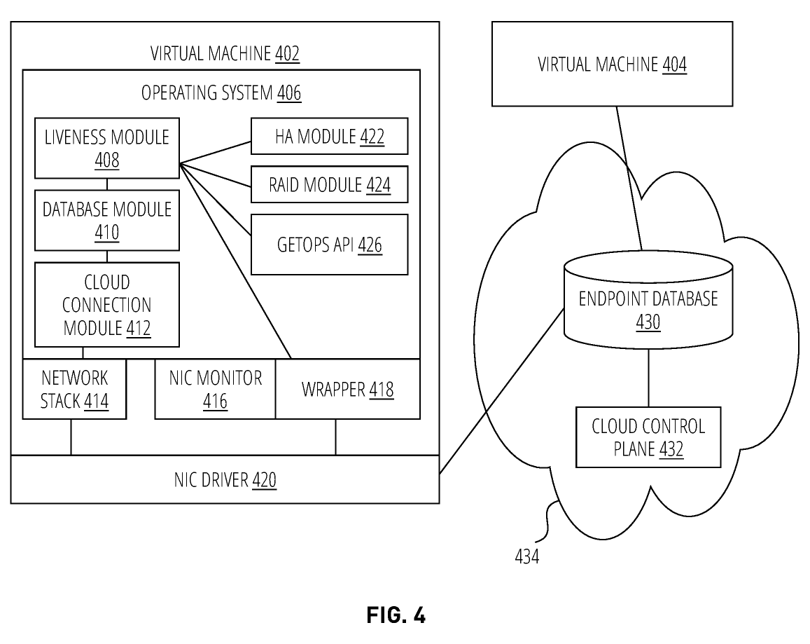

FIG. 4 is a block diagram of an example virtual machine HA pair that deterministically ascertains the functional status of VMs in the HA environment. The HA pair of FIG. 4 includes two virtual machines (e.g., virtual machine 402, virtual machine 404) that are similarly configured (only the components of virtual machine 402 are illustrated for purposes of simplicity of description). The virtual machines are coupled with endpoint database 430 (via an endpoint API as illustrated above), which is part of cloud environment 434, which also includes cloud control plane 432.

As described in greater detail below, once a connection is established between virtual machine 402 and endpoint database 430, a system thread running on virtual machine 402 interacts with various components of virtual machine 402 and/or operating system 406 to get relevant liveness information and pushes the liveness information to endpoint database 430 periodically (e.g., every 5 seconds, every 30 seconds, every 60 seconds).

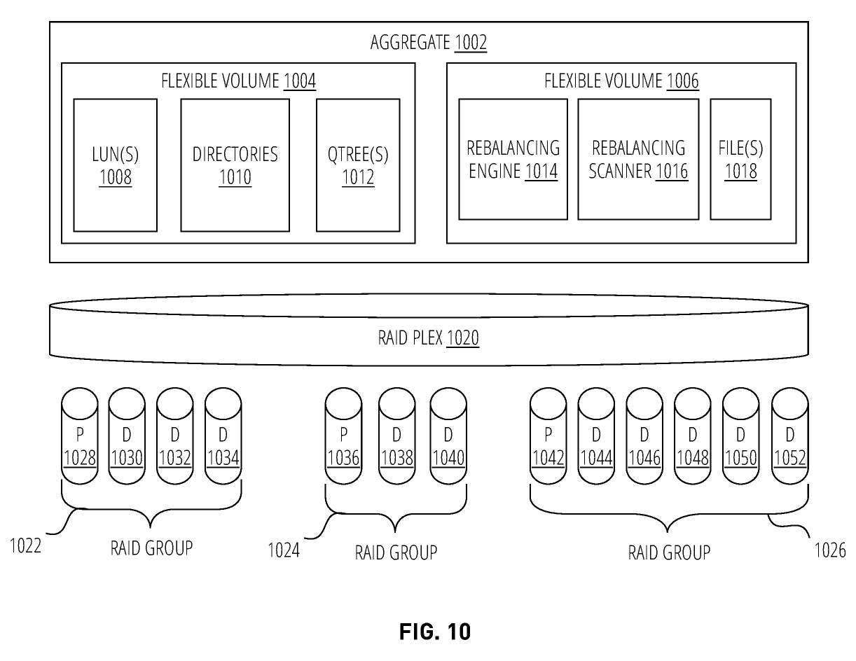

In an example, the liveness information includes one or more of a timestamp, node state information corresponding to the host VM, aggregate state information corresponding to the host VM (aggregates are illustrated in FIG. 10), NIC state information (e.g., from NIC monitor 416), object store state information, client device information (e.g., NFS, SMB, iSCSI, HTTPD, NVMe), version information, etc.

The example of FIG. 4 shows modules utilized to provide the functionality as described herein. In an example, liveness module 408 establishes the connection with endpoint database 430, interacts with other modules within virtual machine 402 (e.g., HA module 422, RAID module 424, getops API 426) to collect liveness information and pushes the liveness information gathered from those (and possibly other) modules to endpoint database 430 periodically via database module 410, cloud connection module 412, network stack 414 and NIC driver 420. In an example, NIC monitor 416 supports interactions between operating system 406 and NIC driver 420.

In an example, cloud control plane 432 checks liveness entries in endpoint database 430 to determine if the corresponding VM is healthy. In an example, cloud control plane 432 can take actions (e.g., replacing a faulty VM) based on one or more rules.

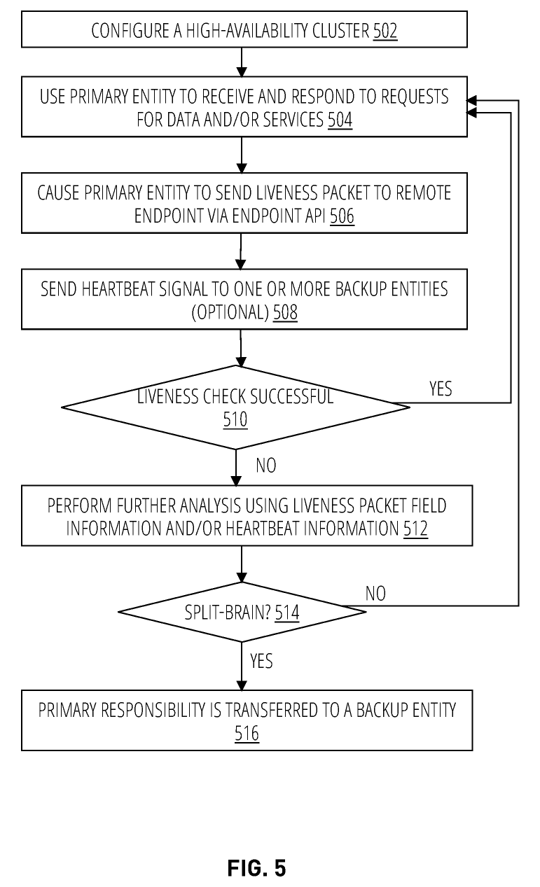

FIG. 5 is a flow diagram corresponding to an example approach to deterministically ascertains the functional status of nodes in the HA environment to more efficiently recover from a split-brain condition. The HA cluster is configured, 502. In an example, the HA cluster is configured as an HA pair (e.g., as illustrated in FIG. 1 and FIG. 2); however, in other configurations a primary entity (e.g., node, VM) can have multiple backup entities. In an example, the HA cluster has an associated management or control plane (e.g., HA control agent 214, storage provider control plane 120, storage provider control plane 222) having one or more components coupled with the entities of the HA cluster.

The primary entity (e.g., primary virtual machine 102, primary virtual machine 202) operates to receive and respond to requests for data and/or services from remote client devices, 504. During this time the one or more backup entities (e.g., secondary virtual machine 104, secondary virtual machine 204) maintain a backup position and are synchronized enough to be able to quickly take over for the primary entity should the primary entity cease to function properly.

When the primary entity is responding to the requests for data and/or services from the remote client devices, the primary entity also sends liveness packets to a remote end point via an endpoint API, 506. The liveness packet can contain various types of information that can be utilized by the control plane to determine which virtual machine should be servicing requests for data and/or services. Example liveness packets are illustrated in FIG. 3. In an example, one or more backup entities can also send a liveness packet to the remote endpoint via the endpoint API. The liveness packet from the backup entity or entities can contain the same or different information as compared to the liveness packet from the primary entity. In an example, a primary virtual machine and/or a backup virtual machine can push liveness information to the remote endpoint.

When the primary entity is responding to the requests for data and/or services from the remote client devices, the primary entity can also send a heartbeat signal to one or more backup entities, 508. This is an optional component that provides additional information to the control plane to analyze the functioning of the components of the HA cluster. The information collected and analyzed by the control plane can be used to determine which entity or entities within the HA cluster is (or are) controlling the flow of data and the state of the entities of the cluster. This can allow the control plane to determine if a split-brain condition exists within the HA cluster and to recover from the split-brain condition in a more efficient manner than would otherwise be possible. This approach thus provides a more efficient and more robust computing environment with reduced opportunities for faulty data and other errors.

If the liveness check is successful, 510, the primary entity continues to receive and to respond to requests from remote client devices, 504. In an example, the liveness check is an evaluation of the timeliness of the liveness packets as received by the remote endpoint. In an example, if the timestamps in the liveness packets are within a pre-selected window (e.g., 30 seconds, 2 minutes, 100 ms), the liveness check is considered successful, 510.

If the liveness check is not successful, 510, the control plane performs further analysis utilizing field information (e.g., node state field 304, aggregate state field 306, NIC state field 308, object store state field 310) and/or heartbeat information from the primary entity and/or one or more backup entities. If, as a result of the further analysis, a split-brain condition is identified, 514, primary responsibility within the HA cluster is transferred to a backup entity, 516. If, as a result of the further analysis, a split-brain condition is not identified, 514, the primary entity continues to respond to requests for data and/or services, 504. Thus, in an example, a failover (or switchover) from the primary entity to the secondary entity happens in response to detection of the split-brain condition and not in response to failure of a single component or interface of the primary entity.

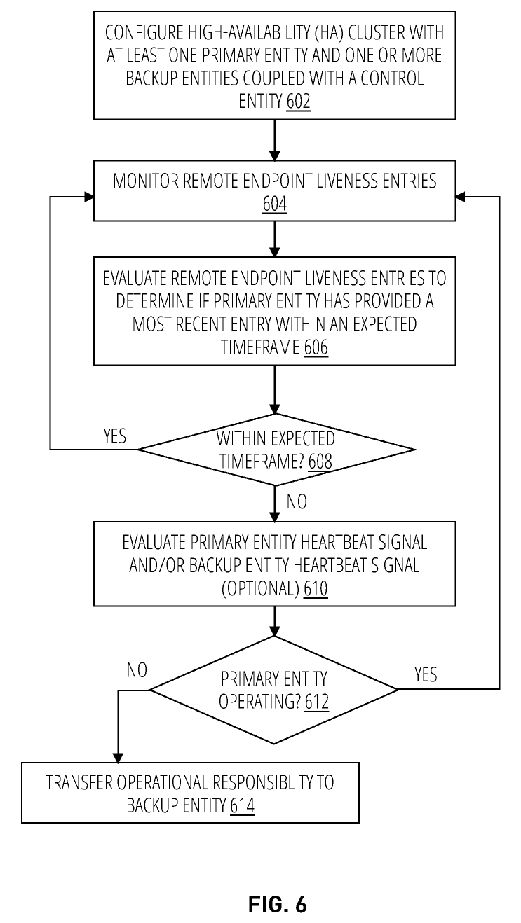

FIG. 6 is a flow diagram corresponding to an example approach to deterministically ascertains the functional status of nodes in the HA environment to more efficiently recover from a split-brain condition. An HA cluster is configured with at least one primary entity (e.g., node, VM, storage system) and one or more backup entities with a control entity, 602. In an example, the HA cluster is an HA pair as illustrated in FIG. 1 and FIG. 2. In an example, the primary entity and the one or more backup entities are interconnected to provide heartbeat signals to each other. As discussed further below, use of the heartbeat signals is an optional portion of the approach described.

The remote endpoint is monitored for liveness entries, 604. In an example, the monitoring is performed by a control plane (e.g., storage provider control plane 120, storage provider control plane 222) of a storage provider (e.g., cloud storage provider). In another example, the monitoring is performed by one or more control entities of the HA pair (e.g., HA control agent 214). In another example, both the control plane and the control agents can monitor the liveness entries and provide corresponding functionalities.

The endpoint liveness entries are evaluated to determine if the primary entity has provided a most recent entry within an expected timeframe, 606. The liveness entries can contain various types of information that can be utilized by the control plane to determine which virtual machine should be servicing requests for data and/or services. Example liveness packets that provide the information in the liveness entries are illustrated in FIG. 3. In an example, one or more backup entities can also send a liveness packet to the remote endpoint via the endpoint API and corresponding entries can be made in the remote endpoint. The liveness packet from the backup entity or entities can contain the same or different information as compared to the liveness packet from the primary entity. In an example, a primary virtual machine and/or a backup virtual machine can push liveness information to the remote endpoint.

The remote endpoint liveness entries are evaluated to determine if the primary entity has provided a most recent entry within an expected timeframe, 606. The timeframe can be any appropriate time frame (e.g., every minute, every 90 seconds) for operation of the HA environment. If the most recent liveness entry is within the expected timeframe (e.g., a minute or less from the previous liveness entry), 608, then operation of the HA environment based on the primary entity continues, 604.

If the most recent liveness entry is not within the expected timeframe, 608, one or more fields and/or one or more heartbeat signals can be evaluated, 610. This analysis can determine if a split-brain condition exists within the HA environment. If the primary entity is operating correctly as determined by the analysis of the liveness entries and/or the heartbeat signals, 612, then no split-brain condition exists and normal operation continues, 604.

If the primary entity is not operating correctly as determined by the analysis of the liveness entries and/or the heartbeat signals, 612, then a split-brain condition may exist. Operational responsibility is transferred to a backup entity, 614, and the primary entity may be shut down, restarted, or otherwise addressed. In an example, operation continues with the backup entity until the primary entity is restored to normal operational parameters and control can be transferred back to the primary entity.

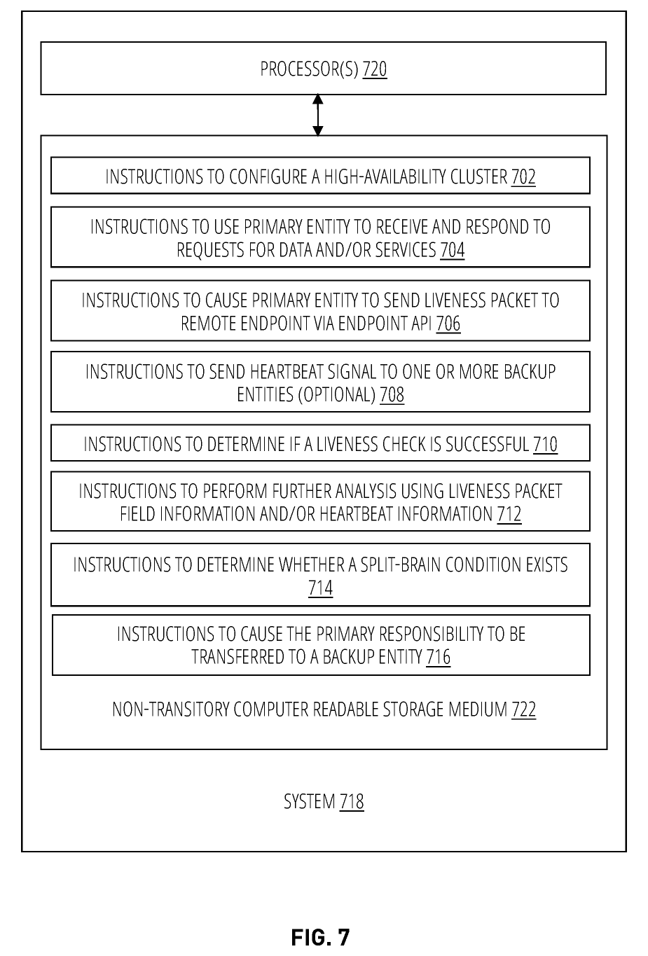

FIG. 7 is a block diagram of an example system to deterministically ascertain the functional status of nodes in the HA environment to more efficiently recover from a split-brain condition. In an example, system 718 can include processor(s) 720 and non-transitory computer readable storage medium 722. In an example, processor(s) 720 and non-transitory computer readable storage medium 722 can be part of a management node having a storage operating system that can provide some or all of the functionality of the ONTAP software as mentioned above.

Non-transitory computer readable storage medium 722 may store instructions 702, 704, 706, 708, 710, 712, 714 and 716 that, when executed by processor(s) 720, cause processor(s) 720 to perform various functions. Examples of processor(s) 720 may include a microcontroller, a microcontroller, a microprocessor, a central processing unit (CPU), a graphics processing unit (GPU), a data processing unit (DPU), an application-specific integrated circuit (ASIC), a field programmable gate array (FPGA), a system on a chip (SoC), etc. Examples of non-transitory computer readable storage medium 722 include tangible media such as random-access memory (RAM), read-only memory (ROM), electrically erasable programmable read-only memory (EEPROM), flash memory, a hard disk drive, etc.

Instructions 702 cause processor(s) 720 to configure the HA cluster. In an example, the HA cluster is configured as an HA pair (e.g., as illustrated in FIG. 1 and FIG. 2); however, in other configurations a primary entity (e.g., node, VM) can have multiple backup entities. In an example, the HA cluster has an associated management or control plane (e.g., HA control agent 214) having one or more components coupled with the entities of the HA cluster.

Instructions 704 cause processor(s) 720 to cause the primary entity (e.g., primary virtual machine 102, primary virtual machine 202) to receive and respond to requests for data and/or services. During this time the one or more backup entities (e.g., secondary virtual machine 104, secondary virtual machine 204) maintain a backup position and are synchronized enough to be able to quickly take over for the primary entity should the primary entity cease to function properly.

Instructions 706 cause processor(s) 720 to cause the primary entity to send liveness packets to the remote endpoint via the endpoint API. When the primary entity is responding to the requests for data and/or services from the remote client devices, the primary entity also sends liveness packets to a remote end point via an endpoint API. The liveness packet can contain various types of information that can be utilized by the control plane to determine which virtual machine should be servicing requests for data and/or services. Example liveness packets are illustrated in FIG. 3. In an example, one or more backup entities can also send a liveness packet to the remote endpoint via the endpoint API. The liveness packet from the backup entity or entities can contain the same or different information as compared to the liveness packet from the primary entity. In an example, a primary virtual machine and/or a backup virtual machine can push liveness information to the remote endpoint.

Instructions 708 cause processor(s) 720 to cause the primary entity to send heartbeat signals to one or more backup entities. When the primary entity is responding to the requests for data and/or services from the remote client devices, the primary entity can also send a heartbeat signal to one or more backup entities. This is an optional component that provides additional information to the control plane to analyze the functioning of the components of the HA cluster. The information collected and analyzed by the control plane can be used to determine which entity or entities within the HA cluster is (or are) controlling the flow of data and the state of the entities of the cluster. This can allow the control plane to determine if a split-brain condition exists within the HA cluster and to recover from the split-brain condition in a more efficient manner than would otherwise be possible. This approach thus provides a more efficient and more robust computing environment with reduced opportunities for faulty data and other errors.

Instructions 710 cause processor(s) 720 to determine if a liveness check is successful. If the liveness check is successful, the primary entity continues to receive and to respond to requests from remote client devices. In an example, the liveness check is an evaluation of the timeliness of the liveness packets as received by the remote endpoint. In an example, if the timestamps in the liveness packets are within a pre-selected window (e.g., 30 seconds, 2 minutes, 100 ms), the liveness check is considered successful.

Instructions 712 cause processor(s) 720 to perform further analysis using the liveness packet fields and/or heartbeat information. If the liveness check is not successful, the control plane performs further analysis utilizing field information (e.g., node state field 304, aggregate state field 306, NIC state field 308, object store state field 310) and/or heartbeat information from the primary entity and/or one or more backup entities. If, as a result of the further analysis, a split-brain condition is identified, primary responsibility within the HA cluster is transferred to a backup entity. If, as a result of the further analysis, a split-brain condition is not identified, the primary entity continues to respond to requests for data and/or services.

Instructions 714 cause processor(s) 720 to determine whether a split-brain condition exists. Instructions 716 cause processor(s) 720 to cause the primary responsibility to be transferred to a backup entity if the primary entity is not operating properly based on the above analysis.

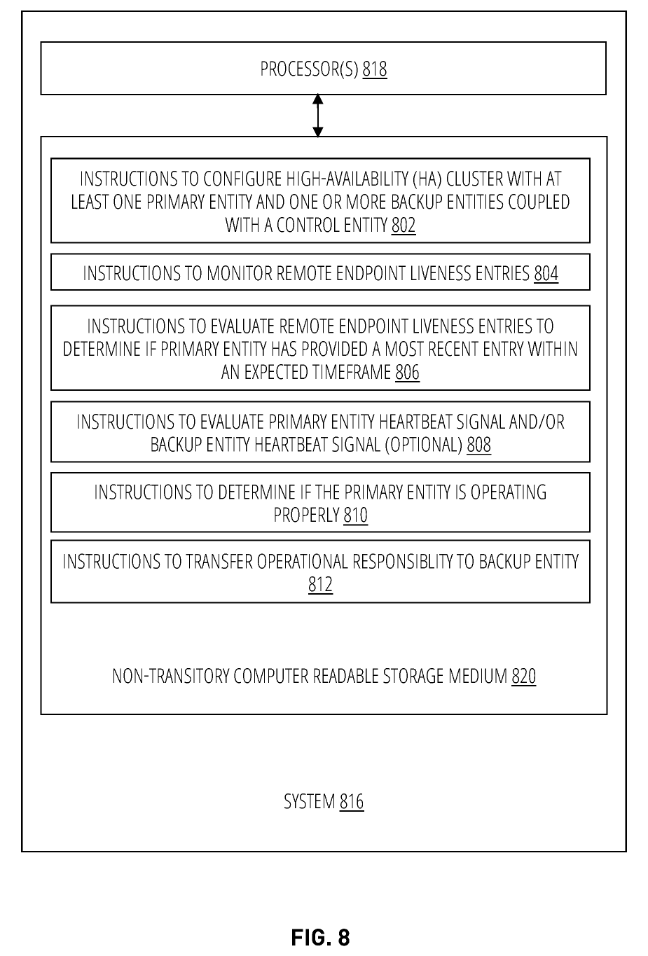

FIG. 8 is a block diagram of an example system to deterministically ascertain the functional status of nodes in the HA environment to more efficiently recover from a split-brain condition. In an example, system 816 can include processor(s) 818 and non-transitory computer readable storage medium 820. In an example, processor(s) 818 and non-transitory computer readable storage medium 820 can be part of a management node having a storage operating system that can provide some or all of the functionality of the ONTAP software as mentioned above.

Non-transitory computer readable storage medium 820may store instructions 802, 804, 806, 708, 808, 810 and 812 that, when executed by processor(s) 818, cause processor(s) 818 to perform various functions. Examples of processor(s) 818 may include a microcontroller, a microcontroller, a microprocessor, a CPU, a GPU, a DPU, an ASIC, an FPGA, a SoC, etc. Examples of non-transitory computer readable storage medium 820 include tangible media such as RAM, ROM, EEPROM, flash memory, a hard disk drive, etc.

Instructions 802 cause processor(s) 818 to configure the HA cluster with at least one primary entity (e.g., node, VM, storage system) and one or more backup entities (e.g., node, VM, storage system) coupled with a control entity. In an example, the HA cluster is an HA pair as illustrated in FIG. 1 and FIG. 2. In an example, the primary entity and the one or more backup entities are interconnected to provide heartbeat signals to each other. As discussed further below, use of the heartbeat signals is an optional portion of the approach described.

Instructions 804 cause processor(s) 818 to monitor liveness entries in the remote endpoint. Instructions 806 cause processor(s) 818 to determine if the liveness entries in the remote endpoint are within an expected timeframe. The liveness entries can contain various types of information that can be utilized by the control plane to determine which virtual machine should be servicing requests for data and/or services. Example liveness packets that provide the information in the liveness entries are illustrated in FIG. 3. In an example, one or more backup entities can also send a liveness packet to the remote endpoint via the endpoint API and corresponding entries can be made in the remote endpoint. The liveness packet from the backup entity or entities can contain the same or different information as compared to the liveness packet from the primary entity. In an example, a primary virtual machine and/or a backup virtual machine can push liveness information to the remote endpoint.

The remote endpoint liveness entries are evaluated to determine if the primary entity has provided a most recent entry within an expected timeframe. The timeframe can be any appropriate time frame (e.g., every minute, every 90 seconds) for operation of the HA environment. If the most recent liveness entry is within the expected timeframe (e.g., a minute or less from the previous liveness entry), then operation of the HA environment based on the primary entity continues.

Instructions 808 cause processor(s) 818 to evaluate the primary entity heartbeat signal and/or backup entity heartbeat signal. If the most recent liveness entry is not within the expected timeframe, one or more fields and/or one or more heartbeat signals can be evaluated. This analysis can determine if a split-brain condition exists within the HA environment. If the primary entity is operating correctly as determined by the analysis of the liveness entries and/or the heartbeat signals, 612, then no split-brain condition exists, and normal operation continues.

Instructions 810 cause processor(s) 818 to determine if the primary entity is operating properly. If the primary entity is not operating correctly as determined by the analysis of the liveness entries and/or the heartbeat signals, 612, then a split-brain condition may exist. Operational responsibility is transferred to a backup entity, 614, and the primary entity may be shut down, restarted, or otherwise addressed. In an example, operation continues with the backup entity until the primary entity is restored to normal operational parameters and control can be transferred back to the primary entity.

Instructions 812 cause processor(s) 818 to transfer operational responsibility to the backup entity.

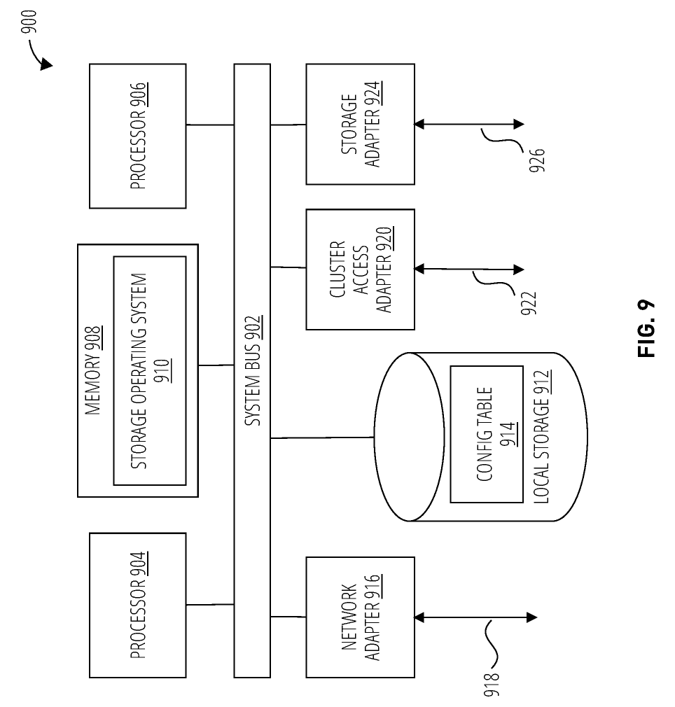

FIG. 9 is a block diagram of a computing platform that can provide one or more virtual machines and deterministically ascertain the functional status of nodes in the HA environment to more efficiently recover from a split-brain condition. In the example of FIG. 9, computing platform 900 includes processor 904 and processor 906, memory 908, network adapter 916, cluster access adapter 920, storage adapter 924 and local storage 912 interconnected by system bus 902. In an example, local storage 912 can be one or more storage devices, such as disks, utilized by the node to locally store configuration information (e.g., in config table 914).

Cluster access adapter 920 provides a plurality of ports adapted to couple computing platform 900 to other nodes (not illustrated in FIG. 9) of a cluster. In an example, Ethernet is used as the clustering protocol and interconnect media, although it will be apparent to those skilled in the art that other types of protocols and interconnects may be utilized within the cluster architecture described herein. Alternatively, where the network elements and disk elements are implemented on separate storage systems or computers, cluster access adapter 920 is utilized by the network element.

In the example of FIG. 9, computing platform 900 is illustratively embodied as a dual processor storage system executing storage operating system 910 that can implement a high-level module, such as a file system, to logically organize the information as a hierarchical structure of named directories, files and special types of files called virtual disks (hereinafter generally “blocks”) on the disks. However, it will be apparent to those of ordinary skill in the art that computing platform 900 may alternatively comprise a single or more than two processor system. In an example, processor 904 executes the functions of the network element on the node, while processor 906 executes the functions of the disk element.

In an example, memory 908 illustratively comprises storage locations that are addressable by the processors and adapters for storing software program code and data structures associated with the subject matter of the disclosure. The processor and adapters may, in turn, comprise processing elements and/or logic circuitry configured to execute the software code and manipulate the data structures. Storage operating system 910, portions of which is typically resident in memory and executed by the processing elements, functionally organizes computing platform 900 by, inter alia, invoking storage operations in support of the storage service implemented by the node. It will be apparent to those skilled in the art that other processing and memory means, including various computer readable media, may be used for storing and executing program instructions pertaining to the disclosure described herein.

Illustratively, storage operating system 910 can be the Data ONTAP® operating system available from NetApp™, Inc., Sunnyvale, Calif. that implements a Write Anywhere File Layout (WAFL®) file system. However, it is expressly contemplated that any appropriate storage operating system may be enhanced for use in accordance with the inventive principles described herein. As such, where the term “WAFL” is employed, it should be taken broadly to refer to any storage operating system that is otherwise adaptable to the teachings of this disclosure. In an example, the ONTAP operating system can provide (or control the functionality of) the rebalancing engine and/or the rebalancing scanner as described herein.

In an example, storage operating system 910 can control operation of computing platform 900 to manage and run one or more virtual machines (e.g., primary virtual machine 102, secondary virtual machine 204, primary virtual machine 202, secondary virtual machine 204). The VMs provide the functionality described above (e.g., FIG. 1, FIG. 2). Storage operating system 910 can also provide additional functionality to computing platform 900.

In an example, network adapter 916 provides a plurality of ports adapted to couple computing platform 900 to one or more clients over one or more connections 918, which can be point-to-point links, wide area networks, virtual private networks implemented over a public network (Internet) or a shared local area network. Network adapter 916 thus may include the mechanical, electrical and signaling circuitry needed to connect the node to the network. Illustratively, the computer network may be embodied as an Ethernet network or a Fibre Channel (FC) network. Each client may communicate with the node over network connections by exchanging discrete frames or packets of data according to pre-defined protocols, such as TCP/IP.

In an example, to facilitate access to disks, storage operating system 910 implements a write-anywhere file system that cooperates with one or more virtualization modules to “virtualize” the storage space provided by the disks. The file system logically organizes the information as a hierarchical structure of named directories and files on the disks. Each “on-disk” file may be implemented as set of disk blocks configured to store information, such as data, whereas the directory may be implemented as a specially formatted file in which names and links to other files and directories are stored. The virtualization module(s) allow the file system to further logically organize information as a hierarchical structure of blocks on the disks that are exported as named logical unit numbers (LUNs).

In an example, storage of information on each array is implemented as one or more storage “volumes” that comprise a collection of physical storage disks cooperating to define an overall logical arrangement of volume block number (vbn) space on the volume(s). Each logical volume is generally, although not necessarily, associated with its own file system. The disks within a logical volume/file system are typically organized as one or more groups, wherein each group may be operated as a Redundant Array of Independent (or Inexpensive) Disks (RAID). Most RAID implementations, such as a RAID-4 level implementation, enhance the reliability/integrity of data storage through the redundant writing of data “stripes” across a given number of physical disks in the RAID group, and the appropriate storing of parity information with respect to the striped data. An illustrative example of a RAID implementation is a RAID-4 level implementation, although it should be understood that other types and levels of RAID implementations may be used in accordance with the inventive principles described herein.

Storage adapter 924 cooperates with storage operating system 910 to access information requested by the clients. The information may be stored on any type of attached array of writable storage device media such as video tape, optical, DVD, magnetic tape, bubble memory, electronic random-access memory, micro-electromechanical and any other similar media adapted to store information, including data and parity information. However, as illustratively described herein, the information is stored on disks or an array of disks utilizing one or more connections 922. Storage adapter 924 provides a plurality of ports having input/output (I/O) interface circuitry that couples to the disks over an I/O interconnect arrangement, such as a conventional high-performance, CF link topology.

FIG. 10 illustrates one embodiment of a block diagram of an aggregate. In one embodiment, a file system layout is provided that apportions an underlying physical volume into one or more virtual volumes (or flexible volume) of a storage system. In an example each flexible volume (e.g., flexible volume 1004, flexible volume 1006) can include a rebalancing engine (e.g., rebalancing engine 1014) and a rebalancing scanner (e.g., rebalancing scanner 1016) that operate to rebalance files as using the approaches described herein.

In such an embodiment, the underlying physical volume is an aggregate comprising one or more groups of disks, such as RAID groups, of the node. In an example, aggregate 1002 has its own physical volume block number (pvbn) space and maintains meta-data, such as block allocation structures, within that pvbn space. Each flexible volume (e.g., flexible volume 1004, flexible volume 1006) has its own virtual volume block number (vvbn) space and maintains meta-data, such as block allocation structures, within that vvbn space. Each flexible volume is a file system that is associated with a container file; the container file is a file in aggregate 1002 that contains all blocks used by the flexible volume. Moreover, each flexible volume comprises data blocks and indirect blocks that contain block pointers that point at either other indirect blocks or data blocks.

LUN(s) 1008, directories 1010, Qtree(s) 1012 and file(s) 1018 may be included within flexible volume 1004 and/or flexible volume 1006, such as dual vbn flexible volumes, that, in turn, are contained within aggregate 1002. In one embodiment, flexible volume 1004 and/or flexible volume 1006 including elements within the flexible volumes may comprise junctions to provide redirection information to other flexible volumes, which may be contained within aggregate 1002, may be stored in aggregate service by other key modules in the distributed file system. Assets, the description of elements being stored within a flexible volume should be taken as exemplary only. Aggregate 1002 is illustratively layered on top of the RAID system, which is represented by at least one RAID plex 1020 (depending upon whether the storage configuration is mirrored), wherein each RAID plex 1020 includes at least one RAID group (e.g., RAID group 1022, RAID group 1024, RAID group 1026). Each RAID group further comprises a plurality of disks, one or more data (D) disks (e.g., 1030, 1032, 1034, 1038, 1040, 1044, 1046, 1048, 1050, 1052) and at least one (P) parity disk (e.g., 1028, 1036, 1042).

Whereas aggregate 1002 is analogous to a physical volume of a conventional storage system, a flexible volume (e.g., flexible volume 1004, flexible volume 1006) is analogous to a file within that physical volume. That is, aggregate 1002 may include one or more files, wherein each file contains a flexible volume and wherein the sum of the storage space consumed by the flexible volumes is physically smaller than (or equal to) the size of the overall physical volume. The aggregate utilizes a physical pvbn space that defines a storage space of blocks provided by the disks of the physical volume, while each embedded flexible volume (within a file) utilizes a logical vvbn space to organize those blocks, e.g., as files. Each vvbn space is an independent set of numbers that corresponds to locations within the file, which locations are then translated to dbns on disks. Since the flexible volume is also a logical volume, it has its own block allocation structures (e.g., active, space and summary maps) in its vvbn space.

In a further embodiment, pvbns are used as block pointers within buffer trees of files stored in a flexible volume. This “hybrid” flexible volume example involves the insertion of only the pvbn in the parent indirect block (e.g., inode or indirect block). On a read path of a logical volume, a “logical” volume (vol) info block has one or more pointers that reference one or more fsinfo blocks, each of which, in turn, points to an inode file and its corresponding inode buffer tree. The read path on a flexible volume is generally the same, following pvbns (instead of vvbns) to find appropriate locations of blocks; in this context, the read path (and corresponding read performance) of a flexible volume is substantially similar to that of a physical volume. Translation from pvbn-to-disk,dbn occurs at the file system/RAID system boundary of the storage operating system.

In a dual vbn hybrid flexible volume example, both a pvbn and its corresponding vvbn are inserted in the parent indirect blocks in the buffer tree of a file. That is, the pvbn and vvbn are stored as a pair for each block pointer in most buffer tree structures that have pointers to other blocks, e.g., level 1 (L1) indirect blocks, inode file level 0 (L0) blocks.

A root (top-level) inode, such as an embedded inode, references indirect (e.g., level 1) blocks. Note that there may be additional levels of indirect blocks (e.g., level 2, level 3) depending upon the size of the file. The indirect blocks (and inode) include pvbn/vvbn pointer pair structures that ultimately reference data blocks used to store the actual data of the file. The pvbns reference locations on disks of the aggregate, whereas the vvbns reference locations within files of the flexible volume. The use of pvbns as block pointers in the indirect blocks provides efficiencies in the read paths, while the use of vvbn block pointers provides efficient access to required meta-data. That is, when freeing a block of a file, the parent indirect block in the file contains readily available vvbn block pointers, which avoids the latency associated with accessing an owner map to perform pvbn-to-vvbn translations; yet, on the read path, the pvbn is available.

A container file is a file in the aggregate that includes all blocks used by a flexible volume. The container file is an internal (to the aggregate) feature that supports a flexible volume; illustratively, there is one container file per flexible volume. Similar to a pure logical volume in a file approach, the container file is a hidden file (not accessible to a user) in the aggregate that holds every block in use by the flexible volume. The aggregate includes an illustrative hidden meta-data root directory that contains subdirectories of flexible volumes.

Specifically, a physical file system directory includes a subdirectory for each flexible volume in the aggregate, with the name of subdirectory being a file system identifier (fsid) of the flexible volume. Each fsid subdirectory (flexible volume) contains at least two files, a file system file and a storage label file. The storage label file is illustratively a 4 kB file that contains meta-data similar to that stored in a conventional raid label. In other words, the storage label file is the analog of a raid label and, as such, contains information about the state of the flexible volume such as, e.g., the name of the flexible volume, a universal unique identifier (uuid) and fsid of the flexible volume, whether it is online, being created or being destroyed, etc.

Aggregate 1002 can be configured as a FlexGroup as supported by the ONTAP® operating system. However, it is expressly contemplated that any appropriate storage operating system may be enhanced for use in accordance with the inventive principles described herein. In the FlexGroup example, a constituent volume refers to the underlying flexible volume (e.g., flexible volume 1004, flexible volume 1006) that provide the storage functionality of the FlexGroup. A FlexGroup is a single namespace that can be made up of multiple constituent volumes ("constituents"). In an example, each FlexGroup contains an entity (e.g., “FlexGroup State”) that has an object corresponding to each constituent of the FlexGroup and collects information for each constituent. The FlexGroup State can also exchange constituent information with other peer FlexGroups.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). The term "logic" may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Reference in the specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment.

It is contemplated that any number and type of components may be added to and/or removed to facilitate various embodiments including adding, removing, and/or enhancing certain features. For brevity, clarity, and ease of understanding, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

The terms “component”, “module”, “system,” and the like as used herein are intended to refer to a computer-related entity, either software-executing general-purpose processor, hardware, firmware and a combination thereof. For example, a component may be, but is not limited to being, a process running on a processor, a processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various non-transitory, computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, on non-transitory, computer readable media including, but not limited to, an ASIC (application specific integrated circuit), CD (compact disc), DVD (digital video disk), ROM (read only memory), floppy disk, hard disk, EEPROM (electrically erasable programmable read only memory), memory stick or any other storage device type, in accordance with the claimed subject matter.

What is claimed is:

1. A high-availability (HA) pair having a primary virtual machine and a secondary virtual machine configured for the primary virtual machine to respond to requests for data and/or services, and for the secondary virtual machine to operate as a backup to the primary virtual machine, the HA pair configured to:
send, periodically with at least the primary virtual machine, a liveness packet to a remote endpoint via an endpoint application program interface (API) when the primary virtual machine is actively responding to the received requests for data or services;
monitor the remote endpoint with a control agent communicatively coupled with the primary virtual machine and the secondary virtual machine, to determine if the primary virtual machine has sent the liveness packet within a pre-selected expected timeframe;
evaluate at least a most recent liveness packet in response to determining that the primary virtual machine has not sent the liveness packet within the pre-selected expected timeframe;
transfer responsibility to respond to subsequent requests for data and/or services to the secondary virtual machine in response to the evaluation determining that the primary virtual machine is not actively responding to requests for data or services.

2. The high-availability pair of claim 1, wherein the remote endpoint comprises a database in a cloud computing environment accessible via one or more APIs including the endpoint API.

3. The high-availability pair of claim 1, wherein evaluating at least a most recent liveness packet in response to determining that the primary virtual machine has not sent the liveness packet within the pre-selected expected timeframe further comprises:
evaluating at least a heartbeat signal from the primary virtual machine; and
evaluating data storage accesses via the primary virtual machine.

4. The high-availability pair of claim 3, further comprising:
evaluating at least a heartbeat signal from the secondary virtual machine; and
evaluating data storage accesses via the secondary virtual machine.

5. The high-availability pair of claim 1, wherein the HA pair is a shared HA pair wherein the secondary virtual machine has access to one or more disks utilized by the primary virtual machine to respond to requests for data and/or services, and the primary virtual machine has access to one or more disks utilized by the secondary virtual machine.

6. The high-availability pair of claim 1, wherein the HA pair is a shared-nothing HA pair wherein the secondary virtual machine does not have access to one or more storage devices utilized by the primary virtual machine to respond to requests for data and/or services, and the primary virtual machine does not have access to one or more storage devices utilized by the secondary virtual machine.

7. The high-availability pair of claim 1, wherein the liveness packet comprises at least a timestamp with one or more of a node state, an aggregate state, a network interface card (NIC) state, and an object store state.

8. The high-availability of claim 1, wherein the liveness packet comprises one or more of a node state, an aggregate state, a network interface card (NIC) state, and an object store state without a corresponding timestamp.

9. A non-transitory computer-readable medium having stored thereon instructions that, when executed by one or more processors, are configurable to cause the one or more processors to:
monitor a remote endpoint with a control agent communicatively coupled with a primary virtual machine and a secondary virtual machine, wherein the primary virtual machine is communicatively coupled to the secondary virtual machine to form a high-availability (HA) pair, the HA pair configured for the primary virtual machine to respond to requests for data or services, and for the secondary virtual machine to operate as a backup to the primary virtual machine, to determine if the primary virtual machine has sent the liveness packet to the remote endpoint within a pre-selected expected timeframe;
evaluate at least a most recent liveness packet in response to determining that the primary virtual machine has not sent the liveness packet within the pre-selected expected timeframe;
transfer responsibility to respond to subsequent requests for data and/or services to the secondary virtual machine in response to the evaluation determining that the primary virtual machine is not actively responding to requests for data or services.

10. The non-transitory computer-readable medium of claim 9, wherein the remote endpoint comprises a database in a cloud computing environment accessible via one or more APIs including an endpoint API.

11. The non-transitory computer-readable medium of claim 9, wherein the instructions further comprise instructions that, when executed by the one or more processors, are configurable to cause the one or more processors to:
evaluate at least a heartbeat signal from the primary virtual machine; and
evaluate data storage accesses via the primary virtual machine.

12. The non-transitory computer-readable medium of claim 11, wherein the instructions further comprise instructions that, when executed by the one or more processors, are configurable to cause the one or more processors to:
evaluate at least a heartbeat signal from the secondary virtual machine; and
evaluate data storage accesses via the secondary virtual machine.

13. The non-transitory computer-readable medium of claim 9, wherein the remote endpoint comprises a database in a cloud computing environment accessible via one or more APIs including the endpoint API.

14. The non-transitory computer-readable medium of claim 9, wherein the HA pair is a shared-nothing HA pair wherein the secondary virtual machine does not have access to one or more storage devices utilized by the primary virtual machine to respond to requests for data and/or services, and the primary virtual machine does not have access to one or more storage devices utilized by the secondary virtual machine.

15. The non-transitory computer-readable medium of claim 9, wherein the liveness packet comprises at least a timestamp with one or more of a node state, an aggregate state, a network interface card (NIC) state, and an object store state.

16. A method comprising:
monitoring a remote endpoint with a control agent communicatively coupled with a primary virtual machine and a secondary virtual machine, wherein the primary virtual machine is communicatively coupled to the secondary virtual machine to form a high-availability (HA) pair, the HA pair configured for the primary virtual machine to respond to requests for data or services, and for the secondary virtual machine to operate as a backup to the primary virtual machine, to determine if the primary virtual machine has sent the liveness packet to the remote endpoint within a pre-selected expected timeframe;
evaluating at least a most recent liveness packet in response to determining that the primary virtual machine has not sent the liveness packet within the pre-selected expected timeframe;
transferring responsibility to respond to subsequent requests for data and/or services to the secondary virtual machine in response to the evaluation determining that the primary virtual machine is not actively responding to requests for data or services.

17. The method of claim 16, wherein the remote endpoint comprises a database in a cloud computing environment accessible via one or more APIs including an endpoint API.

18. The method of claim 16, wherein evaluating at least a most recent liveness packet in response to determining that the primary virtual machine has not sent the liveness packet within the pre-selected expected timeframe further comprises:
evaluating at least a heartbeat signal from the primary virtual machine; and
evaluating data storage accesses via the primary virtual machine.

19. The method of claim 18, wherein evaluating at least a most recent liveness packet in response to determining that the primary virtual machine has not sent the liveness packet within the pre-selected expected timeframe further comprises:
evaluating at least a heartbeat signal from the secondary virtual machine; and
evaluating data storage accesses via the secondary virtual machine.

20. The method of claim 16, wherein the liveness packet comprises at least a timestamp with one or more of a node state, an aggregate state, a network interface card (NIC) state, and an object store state.

21. The method of claim 16, wherein the HA pair is a shared-nothing HA pair wherein the secondary virtual machine does not have access to one or more storage devices utilized by the primary virtual machine to respond to requests for data and/or services, and the primary virtual machine does not have access to one or more storage devices utilized by the secondary virtual machine.
